(19) United States
(12) Patent Application Publication
(10) Pub. No.: US 2006/0147789 A1
(43) Pub. Date: Jul. 6, 2006

(54) Gas blocking anode for a direct liquid fuel cell

(75) Inventors: Alexander Bluvstein, Dimona (IL); Gennadi Finkelshtain, Shoham (IL)

Correspondence Address: GREENBLUM & BERNSTEIN, P.L.C., 1950 ROLAND CLARKE PLACE, RESTON, VA, 20191, US

(73) Assignee: More Energy LTD.,, Lod (IL)

(21) Appl. No.: 11/325,326

(22) Filed: Jan. 5, 2006

Related U.S. Application Data
(63) Continuation-in-part of application No. 10/959,763, filed on Oct. 7, 2004.
(63) Continuation-in-part of application No. PCT/US05/35878, filed on Oct. 5, 2005.
Application No. PCT/US05/35878 is a continuation of application No. 10/959,763, filed on Oct. 7, 2004.

(51) Int. Cl. H01M 4/86

(52) U.S. Cl. 429/41; 429/42

(57) ABSTRACT

An anode for a direct liquid fuel cell in which hydrogen gas is generated as a result of a fuel oxidation or decomposition reaction. The surface of the anode which is intended to face the electrolyte chamber of the fuel cell is substantially completely covered with a polymeric material which prevents at least about 80% of the generated hydrogen gas to pass through the anode into the electrolyte chamber.

### CROSS-REFERENCE TO RELATED APPLICATIONS

The present application is a continuation-in-part of U.S. application Ser. No. 10/959,763, filed Oct. 7, 2004, the entire disclosure whereof is expressly incorporated by reference herein, and is a continuation-in-part of International Application No. PCT/US2005/035878, filed Oct. 5, 2005, the entire disclosure whereof is expressly incorporated by reference herein, which is a continuation of U.S. application Ser. No. 10/959,763, filed Oct. 7, 2004.

### BACKGROUND OF THE INVENTION

1. Field of the Invention

The present invention relates to a gas blocking anode for a Direct Liquid Fuel Cell (DLFC) which uses a hydride fuel and specifically, to an anode which helps to prevent or at least substantially reduce an increase of the ionic resistance of the electrolyte in the fuel cell, which increase is caused by hydrogen bubbles in the electrolyte, and which bubbles result from, inter alia, a decomposition of the hydride fuel. The gas blocking anode of the present invention also helps to prevent or at least substantially reduce the parasitic loss of hydrogen into the electrolyte.

2. Discussion of Background Information

Direct liquid fuel cells are of considerable importance in the field of new energy conversion technologies. In the literature, the most frequently discussed liquid fuel for a DLFC appears to be methanol. The main disadvantages of Direct Methanol Fuel Cells (DMFCs) include the toxicity of methanol, the very poor discharge characteristics at room temperature and the complexity and cost due to high catalyst loading and poor performance.

Fuels based on (metal) hydride and borohydride compounds such as, e.g., sodium borohydride (e.g., in alkaline solution) have a very high chemical and electrochemical activity. Consequently, DLFCs which use such fuels have extremely high discharge characteristics (current density, specific energy, etc.) even at room temperature.

Efficient operation of a DLFC which uses a (boro)hydride fuel requires continuous delivery of the (boro)hydride to the catalyst particles of the anode. For example, borohydride is electrochemically oxidized at the anode by direct reaction with formation of BO₂⁻ and water in accordance with the following equation:
BH₄⁻+8OH⁻=BO₂⁻+6H₂O+8e⁻ (1)

Side reactions include the electrochemical oxidation of the borohydride to H₂ and the non-electrochemical decomposition of the borohydride (self-discharge). The decomposition of a borohydride compound occurs in accordance with the following equation:

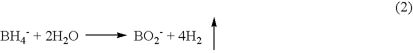

The formation of hydrogen gas as a result of the above side reactions causes several problems. One of these problems includes the passage of hydrogen gas through the anode into the electrolyte chamber, leading to the formation of hydrogen bubbles in the electrolyte and, in turn, to an increase of the electric (ionic) resistivity of the electrolyte. Another problem includes the parasitic loss of hydrogen gas (which is a fuel for the fuel cell as well) into the electrolyte.

### SUMMARY OF THE INVENTION

The present invention provides an anode for a direct liquid fuel cell in which hydrogen gas is generated as a result of a fuel oxidation or decomposition reaction, wherein that surface of the anode which is intended to face the electrolyte of the fuel cell is substantially completely covered with a polymeric material which prevents at least about 80% of the generated hydrogen gas to pass through the anode and into the electrolyte.

In one aspect of the anode, at least about 85% of the hydrogen gas, e.g., at least about 90%, at least about 95%, or at least about 98% of the hydrogen gas may be prevented from entering the electrolyte.

In another aspect, the area resistivity of the combination of the anode with the polymeric material may be not higher than about 1 Ohm·cm², e.g., not higher than about 0.9 Ohm·cm², not higher than about 0.85 Ohm·cm², or not higher than about 0.8 Ohm·cm². As used herein and in the appended claims, the terms “area resistivity” and “resistivity” are used interchangeably.

In yet another aspect, the surface of the anode may be covered with a single layer of polymeric material, or at least two layers of polymeric material may be arranged on the surface of the anode. For example, the at least two layers may comprise different polymeric materials.

In a still further aspect, the polymeric material may comprise one or more layers of polymeric material and may have a total thickness of not more than about 200 μm and/or a total thickness of at least about 25 μm.

In another aspect of the anode of the present invention, the polymeric material may comprise at least one polymer with a hydrophilic group. For example, the hydrophilic group may be an OH, a COOH and/or an SO₃H group. Preferably, the at least one polymer with a hydrophilic group comprises OH groups. In yet another aspect, the at least one polymer with a hydrophilic group may comprise a homopolymer and/or a copolymer of vinyl alcohol, for example, a polymer having a weight average molecular weight of not more than about 100,000 and/or of not less than about 10,000. By way of non-limiting example, the copolymer of vinyl alcohol may comprise a copolymer of vinyl alcohol and one or more ethylenically unsaturated comonomers, e.g., a vinyl alcohol/olefin (e.g., a vinyl alcohol/ethylene) copolymer. Also, the copolymer of vinyl alcohol may comprise at least about 50 mol-% of vinyl alcohol units.

In yet another aspect of the anode of the present invention, at least a part of the polymeric material may be capable of swelling in an aqueous solution.

In a still further aspect, the at least one polymer with a hydrophilic group may be at least partially crosslinked, for example, with a crosslinking agent which comprises a polymer that has at least one functional group which is capable of reacting with a functional group of the hydrophilic polymer. Preferably, the weight ratio of the at least one polymer with a hydrophilic group and the crosslinking agent ranges from about 2:1 to about 1:2.

In another aspect, the at least one polymer with a hydrophilic group may comprise a polymer having OH groups and the crosslinking agent may comprise a polymer selected from polyethylene glycol, polyethylene oxide, a homo- or copolymer of acrylic acid and combinations thereof. For example, the polyethylene glycol may have a number average molecular weight of from about 300 to about 10,000, and the polyethylene oxide may have a number average molecular weight of from about 35,000 to about 200,000.

In another aspect, the at least one polymer with a hydrophilic group may comprise a polymer having OH groups and the crosslinking agent may comprise a polymer which comprises at least one monomeric unit with a carboxylic acid and/or a sulfonic acid group. By way of non-limiting example, the at least one monomeric unit may comprise an ethylenically unsaturated carboxylic acid such as, e.g., acrylic acid, methacrylic acid and maleic acid. For example, the crosslinking agent may comprise a homo- or copolymer of acrylic acid. Non-limiting examples thereof include polyacrylic acid, e.g., polyacrylic acid having a weight average molecular weight of from about 2,000 to about 250,000, and a copolymer of acrylic acid and maleic acid, e.g., a copolymer having a weight average molecular weight of from about 2,000 to about 5,000.

In yet another aspect, the at least one polymer with a hydrophilic group may be at least partially crosslinked with at least one crosslinking agent selected from a silicate, a pyrophosphate, a sugar alcohol, a polycarboxylic acid and an aldehyde. Non-limiting examples of these crosslinking agents include an alkali metal silicate, an alkali metal pyrophosphate, xylitol, sorbitol, sulfosuccinic acid and formaldehyde. By way of non-limiting example, the weight ratio of the at least one polymer with a hydrophilic group and the crosslinking agent may range from about 2:1 to about 1:2.

In yet another aspect of the anode of the present invention, the anode may comprise a metal mesh current collector, e.g., a nickel mesh current collector. Further, the anode may comprise a binder such as, e.g., polytetrafluoroethylene.

The present invention also provides an anode for a direct liquid fuel cell in which hydrogen gas is generated as a result of a fuel oxidation or decomposition reaction, wherein the surface of the anode which is intended to face (and/or come into contact with) an electrolyte of the fuel cell is substantially completely coated with one or more layers of a material which comprises an at least partially crosslinked homopolymer and/or an at least partially crosslinked copolymer of vinyl alcohol with a content of vinyl alcohol units of at least about 50 mol-%. The one or more layers prevent at least about 90% of the generated hydrogen gas from penetrating the anode into the electrolyte chamber. Also, the anode with the one or more layers thereon has a resistivity of not higher than about 0.9 Ohm·cm².

In one aspect of this anode, the one or more layers may comprise at least two layers, a first layer in contact with the anode which comprises a copolymer of vinyl alcohol and one or more ethylenically unsaturated comonomers, and a second layer which is arranged on the first layer and comprises a vinyl alcohol homopolymer.

In another aspect of the anode, the one or more layers may comprise a vinyl alcohol homopolymer.

In yet another aspect, the one or more layers may have a total thickness of from about 25 μm to about 200 μm.

In a still further aspect, the vinyl alcohol polymer may be at least partially crosslinked with one or more crosslinking agents selected from polyethylene glycol, polyethylene oxide and homo- and copolymers of acrylic acid. By way of non-limiting example, the weight ratio of the vinyl alcohol polymer and the crosslinking agent may be from about 2:1 to about 1:2.

In another aspect, the vinyl alcohol polymer may be at least partially crosslinked with a crosslinking agent selected from sodium silicate, sodium pyrophosphate, sorbitol, xylitol, sulfosuccinic acid, formaldehyde and combinations of two or more thereof.

In yet another aspect of the anode, the one or more layers may prevent at least about 95% of the generated hydrogen gas from penetrating the anode with the one or more layers thereon, and the anode with the one or more layers thereon may have a resistivity of not higher than about 0.85 Ohm·cm².

In another aspect, the anode may comprise a nickel mesh current collector.

The present invention also provides a direct liquid fuel cell which comprises an anode of the present invention as set forth above, including the various aspects thereof.

In one aspect, this fuel cell may comprise a metal hydride and/or a metal borohydride compound, for example, sodium borohydride in a fuel chamber thereof.

In another aspect, the electrolyte chamber of the fuel cell may comprise an aqueous alkali metal hydroxide, for example, aqueous potassium hydroxide.

The present invention also provides a direct liquid fuel cell for use with a liquid fuel that is prone to undergo decomposition with generation of hydrogen gas. The fuel cell comprises a cathode; an anode; an electrolyte chamber arranged between the cathode and the anode; a fuel chamber arranged on that side of the anode which is opposite to the side which faces the electrolyte chamber; and one or more layers of polymeric material which are arranged on that surface of the anode which faces the fuel chamber. These one or more layers of polymeric material prevent an at least substantial portion of the hydrogen gas that is present in the fuel chamber (when liquid fuel is present in the fuel chamber) from passing through the anode into the electrolyte chamber.

In one aspect of the fuel cell, the fuel may comprise a metal hydride compound and/or a metal borohydride compound.

In another aspect, the anode may have a single layer of polymeric material thereon, or it may have at least two layers of polymeric material thereon.

In yet another aspect, at least about 90% of the hydrogen gas, for example, at least about 95% of the hydrogen gas, may be prevented from entering the electrolyte chamber.

In a still further aspect of the fuel cell, the resistivity of the anode with the polymeric material thereon may be not higher than about 1 Ohm·cm², e.g., not higher than about 0.9 Ohm·cm².

In another aspect, the one or more layers of polymeric material may have a total thickness of not more than about 200 μm and/or a total thickness of at least about 25 μm.

In another aspect of the fuel cell, the polymeric material may comprise at least one polymer with a hydrophilic group such as, e.g., one or more of OH, COOH and SO₃H groups. In a preferred embodiment, the at least one polymer comprises at least OH groups. By way of non-limiting example, the at least one polymer may comprise a homopolymer and/or a copolymer of vinyl alcohol. The copolymer of vinyl alcohol may, for example, comprise at least about 50 mol-% of vinyl alcohol units.

In yet another aspect, the at least one polymer with a hydrophilic group may be at least partially crosslinked with a crosslinking agent which comprises a polymer that has at least one functional group which is capable of reacting with a functional group of the hydrophilic polymer. By way of non-limiting example, the weight ratio of the at least one polymer with a hydrophilic group and the crosslinking agent may range from about 2:1 to about 1:2. Further, the at least one polymer with a hydrophilic group may comprise a polymer having OH groups and the crosslinking agent may comprise a polymer selected from polyethylene glycol, polyethylene oxide, a homo- or copolymer of acrylic acid and combinations thereof. Also, the at least one polymer with a hydrophilic group may be at least partially crosslinked with at least one crosslinking agent that is selected from an alkali metal silicate, an alkali metal pyrophosphate, a sugar alcohol, a polycarboxylic acid and an aldehyde.

In a still further aspect of the fuel cell, the anode may comprise a nickel mesh current collector and/or a binder which comprises polytetrafluoroethylene.

In another aspect, the electrolyte chamber of the fuel cell may comprise an aqueous alkali metal hydroxide such as, e.g., aqueous potassium hydroxide.

The present invention also provides a method of reducing or substantially preventing an increase in the ionic resistance of an electrolyte of a direct liquid fuel cell which comprises a cathode, an anode, an electrolyte arranged between the cathode and the anode, and a fuel chamber arranged on that side of the anode which is opposite to the side of the electrolyte chamber. The increase in the ionic resistance is caused by hydrogen gas bubbles which are formed as a result of a generation of hydrogen gas by the liquid fuel in the fuel chamber and a migration of the hydrogen gas through the anode into the electrolyte. The method comprises providing the surface of the anode which faces (and/or comes into contact with) the electrolyte with one or more layers of a polymeric material which prevent a substantial portion of the generated hydrogen gas from passing through the anode.

In one aspect of the method, the fuel may comprise a hydride compound and/or a borohydride compound, for example, an alkali metal borohydride. By way of non-limiting example, the fuel may comprise sodium borohydride which is dissolved and/or suspended in a liquid carrier.

In another aspect, at least about 90% of the hydrogen gas, e.g., at least about 95% of the hydrogen gas may be prevented from passing through the anode having the one or more layers of polymeric material thereon.

In yet another aspect of the method, the resistivity of the anode with the one or more layers of polymeric material may be not higher than about 1 Ohm·cm², e.g., not higher than about 0.85 Ohm·cm².

In a still further aspect of the method, the surface of the anode may be provided with a single layer of polymeric material, or at least two layers of polymeric material may be arranged on the surface of the anode.

In another aspect, the one or more layers of polymeric material may have a total thickness of from about 25 μm to about 200 ρm.

In a still further aspect, the polymeric material may comprise at least one polymer with a hydrophilic group selected from one or more of OH, COOH and SO₃H groups. By way of non-limiting example, the at least one polymer may comprise OH groups.

In another aspect, the at least one polymer may comprise a homopolymer and/or a copolymer of vinyl alcohol. Preferably, this homo- and/or copolymer is at least partially crosslinked with a crosslinking agent which comprises a polymer that has at least one functional group which is capable of reacting with a functional group of the homopolymer/copolymer of vinyl alcohol. For example, the crosslinking agent may comprise a polyethylene glycol, a polyethylene oxide, a homo- or copolymer of acrylic acid or any combination of two or more thereof. Alternatively or additionally, the crosslinking agent may comprise an alkali metal silicate, an alkali metal pyrophosphate, a sugar alcohol, sulfosuccinic acid and/or an aldehyde.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic cross section view of a fuel cell which includes an anode according to the present invention;

FIG. 2 shows a schematic cross section view of a cell for measuring the resistivity of an anode of the present invention;

FIG. 3 shows a schematic drawing of a test assembly which is used for determining the gas blocking efficiency of the polymeric material of the anode of the present invention;

FIG. 4 shows a schematic cross section view of an apparatus used in the test assembly shown in FIG. 3;

FIG. 5 shows an exemplary diagram which is used for determining the gas blocking efficiency from data obtained with the test assembly of FIG. 3.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

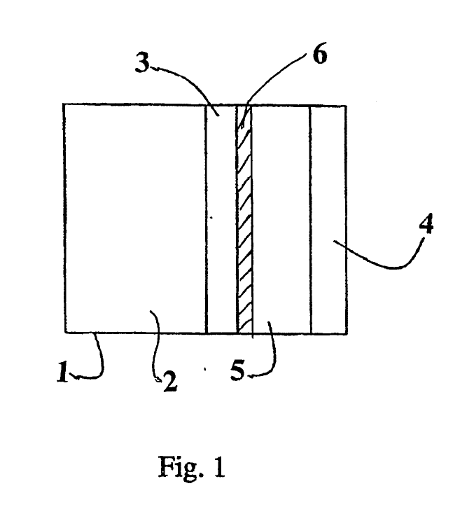

As illustrated in FIG. 1, a DLFC according to the present invention comprises a case or container body 1 which comprises therein a fuel chamber 2 and an electrolyte chamber 5. The fuel chamber 2 contains fuel in the form of, e.g., a hydride or borohydride fuel. The electrolyte chamber contains electrolyte in the form of, e.g., an aqueous alkali metal hydroxide solution (it is noted, however, that the electrolyte may also be a solid or semisolid (e.g., gel) material). An anode 3 is arranged within the case 1 and separates the two chambers 2 and 5. A cathode 4 is also arranged in the case 1 and, together with the anode 3, defines the electrolyte chamber 5. At the anode 3 an oxidation of the liquid fuel takes place. At the cathode a substance, typically oxygen in the ambient air, is reduced. The fuel cell according to the present invention additionally comprises at least one layer of a polymeric material 6 on that surface of the anode which faces the electrolyte chamber 5.

In a conventional DLFC without the anode of the present invention, all or at least a substantial portion of the hydrogen gas formed at the anode 3 and/or in the body of the fuel chamber 2 will gradually pass through the (porous) anode and into the electrolyte chamber 5 where the hydrogen forms bubbles (usually, micro-bubbles) in the electrolyte. This, in turn, results in an increase of the ionic resistance of the electrolyte. The anode of the present invention which is provided with the at least one layer of polymeric material 6 on that surface of the anode 3 which faces the electrolyte chamber 5 prevents all or at least a substantial portion (typically at least about 80%, preferably at least about 90%, and up to about 98 or close to about 100%, hereafter sometimes referred to as “gas-blocking efficiency”) of the hydrogen gas from reaching the electrolyte chamber, whereby an increase in the ionic resistance of the electrolyte can be avoided to an at least substantial extent. The percentage of hydrogen gas which is prevented from reaching the electrolyte chamber may be determined according to the method which is described in the Examples below.

As set forth above, one side (major surface) of the anode 3 is substantially completely (and preferably completely) covered with at least one layer of polymeric material 6. Covering the anode with the polymeric material can be accomplished in various ways. For example, one or more films of polymeric material can be attached to the surface of the anode under pressure and/or by means of a suitable adhesive (applied, e.g. at the edges of the anode). Preferably, the one or more layers of polymeric material 6 are (successively) applied by a coating operation. For example, one or more solutions and/or suspensions of the desired polymeric material(s) may be applied onto the surface of the anode, and after the or each coating operation the solvent(s) may be at least partially removed, e.g., by allowing the solvents to evaporate under ambient conditions, by heating and/or by applying a vacuum. A non-limiting example of a typical coating process is described in the Examples below. The polymeric material does not necessarily have to be in direct contact with the anode surface (although direct contact is preferred), as long as the polymeric material is capable of preventing a substantial portion of the hydrogen gas from entering the electrolyte chamber, and as long as the conductivity of the combination of anode and polymeric layer is not significantly adversely affected by the lack of direct contact.

Where two or more layers of polymeric material (e.g., two, three or four layers of polymeric material) are applied, the layers may comprise the same or different polymer(s). Layers of the same polymer(s) may be of advantage, for example, if a single coating operation does not afford the desired thickness (and/or mechanical strength) of the polymeric material layer and/or if it is difficult to achieve a continuous coating film (substantially without any holes) with a single coating operation.

Two or more layers which comprise different polymers in at least two of the layers may be expedient for, e.g., imparting a combination of desired characteristics to the polymeric material. For example, a first layer of polymeric material which is in direct contact with the anode may comprise one or more polymers which provide a good adhesion to the anode surface, whereas a layer which comprises one or more polymers which is (are) different from the polymer(s) in the first layer and which layer is arranged on the first layer may provide other desired characteristics, for example, a high conductivity. In this regard, it is preferred for the combination of anode and polymeric material to have a resistivity of not substantially higher than about 1 Ohm·cm², even more preferred of not higher than about 0.95 Ohm·cm², particularly not higher than about 0.9 Ohm·cm², not higher than about 0.85 Ohm·cm², or not higher than about 0.8 Ohm·cm². The conductivity (resistivity) may be measured according to the method described in the Examples below.

Irrespective of whether one or two (or more) layers of polymeric material are provided on the anode surface, each of these layers may independently comprise a single polymer or a mixture of two or more polymers. Of course, if two or more layers are provided, these layers may have the same or a different thickness.

The one or more layers of polymeric material arranged on the anode will usually have a combined thickness of not more than about 0.2 mm, e.g., not more than about 0.15 mm. On the other hand, the combined thickness will preferably be not lower than about 0.025 mm, e.g., not lower than about 0.03 mm.

Suitable polymers for use in the one or more layers of polymeric material 6 include those which provide, alone or in combination, both a satisfactory conductivity and a high gas-blocking efficiency (a low permeability for hydrogen gas), particularly in the conventional operating temperature range of a DLFC, i.e., from room temperature to about 60° C. Also, the one or more polymers should provide sufficient mechanical strength and maintain mechanical integrity to a sufficient extent even when exposed to an alkaline solution (in particular, an aqueous electrolyte) at a temperature of up to about 60° C. for extended periods of time. In this regard, an example of an aqueous electrolyte of the type conventionally used in a DLFC is aqueous potassium hydroxide solution (e.g., about 6M to about 7M KOH). Sufficient adhesion to the anode surface is also a desired characteristic. As mentioned above, it is not necessary for a single polymer to exhibit all of these desirable properties in order to be suitable for use in the present invention. A combination of two or more polymers which together provide these properties is equally suitable.

Regarding adhesion of the polymers to the anode surface, it may be advantageous in certain cases to subject the surface of the anode that is to carry the gas blocking layer to a surface treatment in order to improve adhesion. Suitable surface treatments are readily apparent to those of skill in the art. A preferred surface treatment comprises a hydrophilization treatment, for example, a hydrophilization treatment as it is disclosed in, e.g., the co-pending U.S. application having the title “Hydrophilized Anode for a Direct Liquid Fuel Cell” (attorney docket P28865), filed concurrently herewith. The entire disclosure of this application is expressly incorporated by reference herein.

Examples of polymers which provide a satisfactory conductivity include those which are able to dissolve or swell in aqueous solutions. A high gas-blocking efficiency may be achieved, for example, by crosslinking suitable polymer chains, which at the same time will increase the mechanical strength of the polymer layer.

Preferred polymers for use in the present invention include those which comprise one or more types of hydrophilic groups such as, e.g., OH, COOH and/or SO₃H groups. Non-limiting examples of such polymers are homo- and copolymers which comprise units of vinyl alcohol, acrylic acid, methacrylic acid, and the like. Of course, polymers with different hydrophilic groups may also be useful. The term “hydrophilic groups” as used herein and in the appended claims is meant to encompass groups which have affinity for and/or are capable of interacting with, water molecules, e.g., by forming hydrogen bonds, ionic interactions, and the like. Preferred examples of polymers with hydrophilic groups for use in the present invention are polymers which comprise at least OH groups, in particular, the homo- and copolymers of vinyl alcohol.

Non-limiting examples of copolymers of vinyl alcohol comprise units of vinyl alcohol and units of one or more (e.g., one or two) ethylenically unsaturated comonomers. Preferred comonomers include C₂-C₈ alkenes such as, e.g., ethylene, propylene, butene-1, hexene-1, and octene-1. Of course, other comonomers may be used as well such as, e.g., vinylpyrrolidone, vinyl chloride and methyl methacrylate. A particularly preferred comonomer is ethylene. Non-limiting specific examples of suitable copolymers include the Mowiol®, Exceval® and Moviflex® vinyl alcohol/ethylene copolymers which are commercially available from Kuraray Specialities Europe (Frankfurt, Germany), in particular, those with a relatively low ethylene content and/or a degree of hydrolysis of from about 97% to about 99% and/or a degree of polymerization of from about 1,000 to about 2,000 such as, e.g., Exceval® grades RS 1113 and RS 1117.

In the copolymers of vinyl alcohol (or any other monomer which comprises hydrophilic groups) and comonomers without hydrophilic groups (e.g., alkenes and the like), the vinyl alcohol units will usually provide the desired ionic conductivity, and the comonomer(s) will preferably promote the adhesion of the polymer to the substrate (the anode surface).

In the copolymers of vinyl alcohol, the units of vinyl alcohol are preferably present in an amount of at least about 50 mol-%, particularly in copolymers where the comonomer(s) do not comprise any hydrophilic groups.

The average molecular weight of the homo- and copolymers of vinyl alcohol (or any other polymers) for use in the present invention is not particularly critical, but will usually be in the conventional range for this type of polymers, i.e., not significantly higher than about 100,000 and not significantly lower than about 10,000, e.g., not significantly lower than about 30,000 (expressed as weight average molecular weight).

In order to increase the mechanical strength and the gas-blocking efficiency of a polymer with hydrophilic groups for use in the present invention, for example the homo- and copolymers of vinyl alcohol set forth above, it will usually be of advantage to crosslink the polymer chains. Suitable sites for crosslinking include the hydrophilic groups of the polymer molecules and/or any other functionalities (including ethylenically unsaturated bonds) that may be present in the polymer molecules. Suitable crosslinking agents include those which comprise in their molecule at least two (e.g., two, three, four of five) functional groups which are capable of reacting (or at least strongly interacting) with one or more types of functional groups present in the polymer molecule. The reaction between the functional groups preferably comprises a polycondensation (including a polyaddition), an ionic or free radical polymerization, or any other type of reaction which results in the formation of (preferably covalent) bonds between the reactants. The crosslinking agent may be of organic or inorganic nature, monomeric or polymeric, and two or more crosslinking agents may be employed, if desired.

Non-limiting and preferred examples of crosslinking agents for the crosslinking of homo- and copolymers of vinyl alcohol as well as other types of polymers include polymeric crosslinking agents such as, e.g., polyalkylene glycols (e.g., those comprising one or more C₁₋₆ alkylene glycols such as, e.g., ethylene glycol, propylene glycol, butylene glycol and hexylene glycol), preferably polyethylene glycol, polyalkylene oxides, in particular, polyethylene oxide in its broadest sense (including, e.g., diol-, triol- and tetrol-initiated polyethylene oxides and ethylene oxide/propylene oxide copolymers), homo- and copolymers of ethylenically unsaturated acids such as, e.g., acrylic acid, methacrylic acid and maleic acid, and monomeric species such as, e.g., alkali metal silicates and pyrophosphates (e.g., sodium or potassium silicate and sodium or potassium pyrophosphate), sugar alcohols (e.g., xylitol, sorbitol, etc.), saturated and unsaturated mono- and polycarboxylic acids which may optionally comprise additional functional groups (e.g., oxalic acid, succinic acid, glutaric acid, adipic acid, maleic acid, fumaric acid, sulfosuccinic acid, malic acid, tartaric acid, citric acid, etc.) and carbonyl compounds, in particular, aldehydes (e.g., formaldehyde). Of course, these compounds may optionally employed as precursors and/or derivatives thereof. For example, polycarboxylic acids may be employed as, e.g., anhydrides or esters and in partially or completely neutralized form. These crosslinking agents will usually be employed in the form of a solution. For example, in the case of sulfosuccinic acid, a preferred concentration range is from about 0.1% to about 2% by weight, e.g., from about 0.2% to about 1% by weight.

In the case of polymeric crosslinking agents, the average molecular weight thereof is not particularly critical and commercially available materials may be employed. For example, the number average molecular weight of commercially available polyethylene glycols is typically in the range of from about 300 to about 10,000, whereas for commercially available polyethylene oxide the number average molecular weight is typically in the range of from about 35,000 to about 200,000. In the case of polyacrylic acid, the weight average molecular weight usually ranges from about 2,000 to about 250,000 (they will usually be employed in the form of a solution at a preferred concentration of from about 0.1% to about 3% by weight, e.g., from about 0.5% to about 2% by weight), and in the case of copolymers of acrylic acid and maleic acid, the weight average molecular weight usually ranges from about 2,000 to about 5,000, e.g., around 3,000 (they will usually be employed in the form of a solution at a preferred concentration of from about 0.1% to about 3% by weight, e.g., from about 0.5% to about 2% by weight).

When homo- and/or copolymers of vinyl alcohol are to be crosslinked for the purposes of the present invention, the weight ratio of these polymers and the crosslinking agent(s), e.g., the crosslinking agents set forth above, preferably ranges from about 2:1 to about 1:2. Of course, ratios outside this range may be used as well and, depending on the specific components employed, may even afford more desirable results. One of ordinary skill in the art will be aware of or be able to readily ascertain suitable weight ratios for other polymers and/or other crosslinking agents.

The anode of the present invention may be any anode which is suitable for the present type of fuel and DLFC. The anode will usually comprise a porous material that is pervious to gaseous and liquid substances, and may have been produced by wet or dry technologies. Of course, the materials thereof should be chemically stable and should be chemically benign with respect to the fuel. A non-limiting example of an anode for use in the present invention comprises a metal mesh current collector, e.g., a nickel or stainless steel mesh, which has attached to it a porous active layer. This active layer may comprise, by way of non-limiting example, activated carbon carrying a catalytically active material (such as a metal, for example Pt, Pd, Ru, Rh, to name just a few), and a binder, typically a polymeric material such as polytetrafluoroethylene, and the like. Of course, other materials for making the anode of the present invention may be used as well. For example, instead of the metal mesh, a metal foam, or hydrophilic carbon paper may be used.

The following non-limiting examples illustrate the production of anodes according to the present invention which are coated with polyethylene glycol-crosslinked vinyl alcohol homo- and copolymers. The anodes are composed of the following materials:

(1) Ni mesh (58 mesh, wire diameter 0.14 mm, thickness about 500 μm) with an active layer of 85% by weight of carbon black catalyst and 15% by weight of polytetrafluoroethylene (made by wet technology);

(2) Ni mesh (40 mesh, wire diameter 0.14 mm, thickness about 400 μm) with an active layer of 80% by weight of carbon black catalyst and 20% by weight of polytetrafluoroethylene (dry technology).

The coating materials used in the Examples are as follows:

Polyvinylalcohol (PVA, Merck): M_{w}=72,000

Polyethylene glycol (PEG, Aldrich): Mₙ=300

Vinyl alcohol/ethylene copolymer (VAE, Aldrich): ethylene content 27 mol-%

### EXAMPLE 1

A solution is prepared by dissolving 7.31 g of PVA and 4.69 g of PEG in 88 g of de-ionized water under stirring and heating the mixture at 70° C. for 2 hours. One ml of the solution is applied onto one surface of the anode (20 cm²) and is then dried in air at ambient temperature for 20 min. Then 1 ml of the same solution is applied onto the first layer, whereafter the anode is transferred to an oven and dried at 120° C. for 2 hours.

The resistivity of the resultant coated anode is 0.8 Ohm·cm², and the gas-blocking efficiency thereof is 99%.

### EXAMPLE 2

A solution is prepared by dissolving 0.6 g of VAE and 0.4 g of PEG in 29 g of n-propanol/water (1:1) under stirring and heating the mixture at 70° C. for 2 hours. One ml of the solution is applied onto one surface of the anode (20 cm²) and then dried in air at ambient temperature for 20 min. Then 1 ml of the solution from Example 1 is applied onto the first layer, whereafter the anode is transferred to an oven and dried at 90° C. for 2 hours.

The resistivity of the resultant coated anode is 0.99 Ohm·cm², and the gas-blocking efficiency thereof is 94%.

### EXAMPLE 3

One ml of the solution from Example 2 is applied onto one surface of the anode (20 cm²) and is dried in air at ambient temperature for 20 min. Then 1 ml of the same solution is applied onto the first layer and the resultant coated anode is transferred to an oven and dried at 90° C. for 2 hours.

The resistivity of the resultant coated anode is 0.88 Ohm·cm², and the gas-blocking efficiency thereof is 89%.

The resistivity of the coated anodes in the above Examples may be determined as follows:

Method Basics

The method is based on a DC applied to an ionic conductor in a porous object and a simultaneous measurement of the potential difference of the electrolyte across the object in the thickness direction thereof. A four-electrode cell is used for measurements. Two of the electrodes are “current source” auxiliary electrodes and the two others are identical “potential sense” reference electrodes.

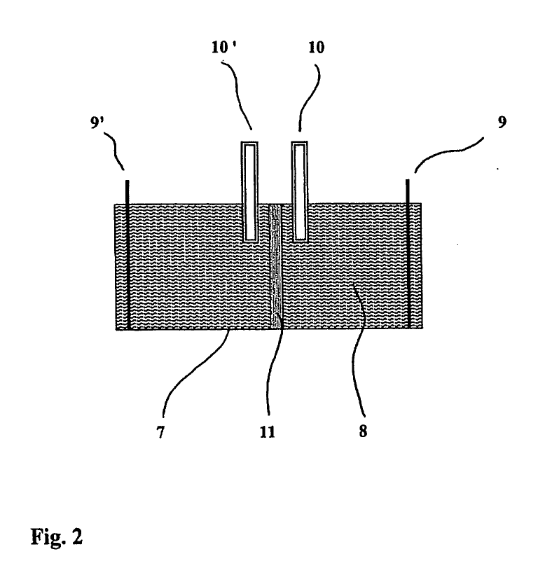

FIG. 2 shows a schematic cross section view of a cell for measuring the electric resistivity of an object. A cell 7 is filled with electrolyte 8. The cell is provided with “current source” electrodes 9, 9′ (working electrode and counter electrode) and “potential sense” electrodes 10, 10′ (sense electrode and reference electrode). The object 11 whose resistivity is to be measured is arranged inside the cell 7 so as to be in contact with the electrolyte 8 on both major surfaces thereof.

The resistance of a porous object impregnated with an electrolyte is determined as resistance difference between capillaries of the “potential sense” electrodes with and without the object under measurement. The resistance R is calculated according to equation (1):
R═R₁−R₀=(ΔE₁−ΔE₀)/I, (1)
where R₁ and ΔE₁ are resistance and potential difference, respectively with object, and R₀ and ΔE₀ are resistance and potential difference without object. I is the source current. Two measurements are carried out: one for electrolyte without object and another one with object impregnated with electrolyte. R₀ also includes an empiric temperature correction: R₀(t₂)=R₀(t₁)*[1−0.017(t₂−t₁)] (for the temperature range of 20-27° C.). The area resistivity p of the object (anode) is calculated according to equation (2):
ρ=R·S (2)
where S is the object surface area.

Equipment and Materials
1. Potentiostat/galvanostat, current range ±100 mA, current accuracy of 0.1%, voltage measurement accuracy of 0.01 mV;
2. Measurement cell with two “source” electrodes;
3. Two “potential sense” electrodes: Hg/HgO electrodes (Koslow, Radiometer Analytical) filled with 6.6M KOH.

Procedure
1. Assemble cell without the anode to be measured.
2. Fill cell with electrolyte (6.6 M KOH) using holes for the “source” electrodes up to ⅔ of the height; insert “source” electrodes. Measure electrolyte temperature.
3. Insert two Hg/HgO “potential sense” electrodes (filled with 6.6M KOH).
4. Connect “source” electrodes to Work Electrode and Counter Electrode wires of potentiostat; connect “potential sense” electrodes to Reference Electrode and Sense Electrode wires.

5. By means of control interface select galvanostatic mode of operation and program the following steps:

| | Sign and amplitude (mA) |
|---|---|
| Step # | of current pulse |
| 1 | +20 |
| 2 | −20 |
| 3 | +40 |
| 4 | −40 |
| 5 | +60 |
| 6 | −60 |
| 7 | +80 |
| 8 | −80 |
| 9 | +100 |
| 10 | −100 |

The duration of each step is 1 s (total duration 10 s). The potential read-out frequency is 0.2 s. Start program, print data table, plot ΔE(mV)vs. I(mA). Approximate branches of E(I) by linear lines for positive and for negative current values. Absolute values of slopes are equal to the resistance R₀.
6. Disconnect wires of potentiostat, pull out all electrodes, empty and disassemble cell, rinse with distilled water.
7. Assemble cell with anode to be tested. Repeat steps 2.-6. under the same temperature condition and determine R₁.
8. Calculate the resistance of the electrolyte in the anode using eq. (1), calculate resistivity of anode using eq. (2). The resistivity of the electrolyte is taken from reference data, S=4 cm², thickness of anode is measured separately. The gas-blocking efficiency (E_{GBL}) of the gas-blocking layer (GBL) of the coated anodes of the above Examples may be determined as follows. E_{GBL} is calculated according to equation (3):

$${E}_{GBL} = 100 \cdot ( 1 - \frac{{V}_{GBL}}{V} ) \qquad ( 3 )$$

where V_{GBL} is the volume of hydrogen gas that penetrates into the electrolyte chamber, and V is the total volume of hydrogen gas that is produced at the anode/in the fuel chamber.

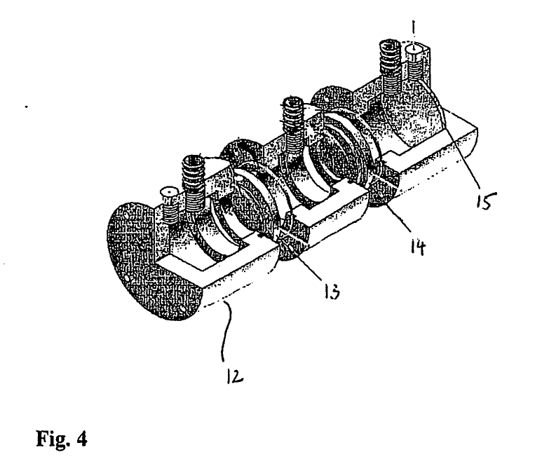

In order to determine E_{GBL}, it is necessary to generate hydrogen gas at a constant pre-determined rate and to measure its flow from the side of the GBL. For this purpose, a triple-chamber cell, shown in FIG. 4, may be used.

The cell 12 is produced from alkali-resistant plastic Delrin™ and is equipped with standard 4 cm² electrodes 13, 15. It is assembled using bolts and is leak-proofed by rubber O-rings. A Ni plate serves as counter electrode 15; a porous polypropylene membrane 14 (Celgard™) which is glued in a standard electrode frame is used as separator. The anode 13 with the GBL to be tested is arranged in the cell 12. The cell is filled with 4M KOH solution; the level thereof must be the same in all three chambers of the cell 12. The anode 13 to be tested must be totally immersed in electrolyte.

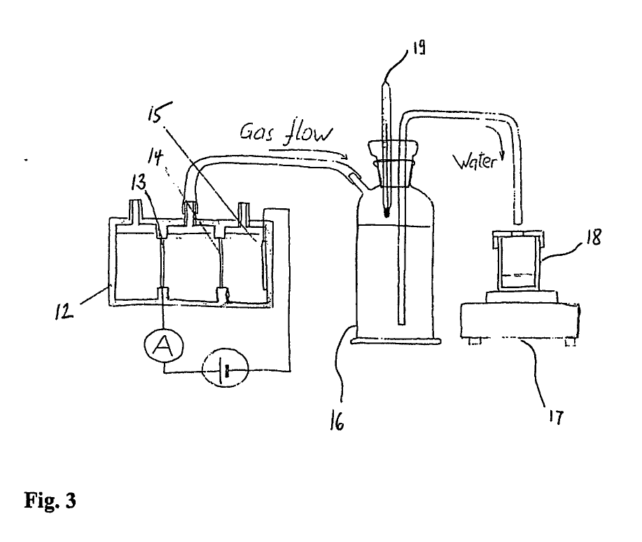

Cell 12 is connected to a test assembly as shown in FIG. 3. The negative terminal of a DC current source (in series with an ammeter) is connected to anode 13 and the positive terminal is connected to Ni counter-electrode 15. Hydrogen gas is generated at a constant rate under a constant current load at anode 13, and oxygen is generated at counter-electrode 15. Membrane 14 which is arranged between the electrodes 13, 15 separates the flows of hydrogen and oxygen.

E_{GBL} is calculated as the volume of hydrogen gas that enters the central chamber of the cell 12 divided by the known total volume of generated hydrogen gas.

A gas outlet of the central chamber of cell 12 is connected to a water-filled Drexel bottle 16 (equipped with thermometer 19) by a silicon rubber tube. The hydrogen gas from the central chamber pushes water from Drexel bottle 16 into a beaker 18 placed on balance 17. The volume of hydrogen gas per time unit from the central chamber of cell 12 is obtained from the weight change of beaker 18 with time.

Equipment and Materials
1. Cell
2. Laboratory DC power supply (model GPC-3020)
3. Ammeter (Fluke 45 Multimeter)
4. Drexel bottle (250 ml) with built-in thermometer
5. Laboratory balance A&D GX400, resolution 0.001 g
6. PC with RSkey software

Measurement Procedure
1. Fill cell with 4M KOH.
2. Fill Drexel bottle with water and connect to cell.
3. Position outlet tube of Drexel bottle above opening in bottle cover so that it does not touch the cover.
4. Turn on PC and start RSkey software to read out the balance data.
5. Turn on DC power supply and set constant current of 100 mA/cm²; record data in MS Excel format (one point per minute) for one hour.
6. Write down temperature of gas in Drexel bottle.
7. Turn off power supply.

Example of Measurement and Calculation of E_{GBL}

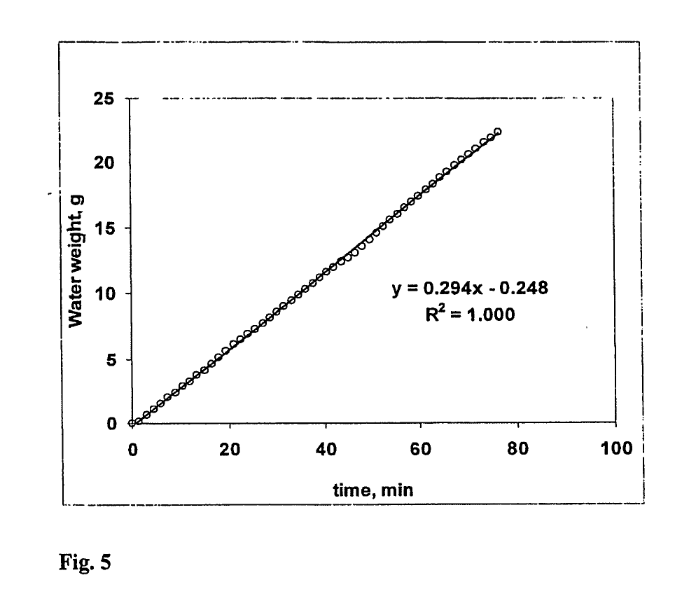

FIG. 5 demonstrates plotted data obtained on anode #328 from Trumem composite. The slope of the line in the weight-time coordinates corresponds to the rate of water replacement and is equal to the hydrogen gas leaving the central chamber of the cell 12. V_{GBL}=0.294 ml/min.

The total hydrogen gas generation rate V under a total current of I=0.4 A (0.1 A/cm²·4 cm²) taking into account the temperature correction at t=25° C. is equal to:

$$V = I \cdot \frac{22400 \cdot 60}{2 F} \cdot \frac{273 + t}{273} \qquad ( 4 )$$

F=96500 Coulombs/mol is Faraday's number.

$$V = 0.4 \frac{22400 \cdot 60}{2 \cdot 96500} \cdot \frac{273 + 25}{273} = 3.041 ( ml / min ) \qquad ( 5 )$$

E_{GBL} expressed in percent is equal to:

$$\begin{matrix}{E}_{GBL} = 100 \cdot ( 1 - \frac{{V}_{GBL}}{V} ) & ( 3 ) \\ {E}_{GBL} = 100 \cdot ( 1 - \frac{0.294}{3.041} ) = 90.3 \% & ( 6 )\end{matrix}$$

It is noted that the foregoing examples have been provided merely for the purpose of explanation and are in no way to be construed as limiting of the present invention. While the present invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

What is claimed is:

1. An anode for a direct liquid fuel cell in which hydrogen gas is generated as a result of a fuel oxidation or decomposition reaction, wherein a surface of the anode which is intended to face an electrolyte of the fuel cell is substantially completely covered with a polymeric material which prevents at least about 80% of the generated hydrogen gas to pass through the anode into the electrolyte.

2. The anode of claim 1, wherein at least about 90% of the hydrogen gas is prevented from entering the electrolyte.

3. The anode of claim 2, wherein a resistivity of a combination of the anode with the polymeric material thereon is not higher than about 1 Ohm·cm².

4. The anode of claim 1, wherein the polymeric material comprises one or more layers of polymeric material and the one or more layers have a total thickness of from about 25 μm to about 200 μm.

5. The anode of claim 1, wherein the polymeric material comprises at least one polymer with a hydrophilic group.

6. The anode of claim 5, wherein the hydrophilic group is selected from one or more of OH, COOH and SO₃H groups.

7. The anode of claim 6, wherein the at least one polymer with a hydrophilic group comprises at least one of a homopolymer and a copolymer of vinyl alcohol.

8. The anode of claim 6, wherein the at least one polymer with a hydrophilic group comprises a vinyl alcohol/alkene copolymer.

9. The anode of claim 5, wherein the at least one polymer with a hydrophilic group is at least partially crosslinked with at least one crosslinking agent which comprises a polymer that has at least one functional group which is capable of reacting with a functional group of the hydrophilic polymer.

10. The anode of claim 9, wherein the at least one polymer with a hydrophilic group comprises a polymer having OH groups and the at least one crosslinking agent comprises at least one polymer selected from polyethylene glycol, polyethylene oxide, a homo- or copolymer of acrylic acid and combinations of two or more thereof thereof.

11. The anode of claim 10, wherein the crosslinking agent comprises at least one of a polyethylene glycol with a number average molecular weight of from about 300 to about 10,000 and a polyethylene oxide with a number average molecular weight of from about 35,000 to about 200,000.

12. The anode of claim 9, wherein the at least one polymer with a hydrophilic group comprises a polymer having OH groups and the at least one crosslinking agent comprises a polymer comprising a monomeric unit having at least one of a carboxylic acid and a sulfonic acid group.

13. The anode of claim 12, wherein the monomeric unit comprises an ethylenically unsaturated carboxylic acid.

14. The anode of claim 13, wherein the ethylenically unsaturated carboxylic acid is selected from acrylic acid, methacrylic acid, maleic acid and any combinations thereof.

15. The anode of claim 12, wherein the at least one crosslinking agent comprises a homo- or copolymer of acrylic acid.

16. The anode of claim 15, wherein the at least one crosslinking agent comprises a polyacrylic acid.

17. The anode of claim 16, wherein the polyacrylic acid has a weight average molecular weight of from about 2,000 to about 250,000.

18. The anode of claim 15, wherein the crosslinking agent comprises a copolymer of acrylic acid and maleic acid.

19. The anode of claim 18, wherein the crosslinking agent has a weight average molecular weight of from about 2,000 to about 5,000.

20. The anode of claim 9, wherein the at least one polymer with a hydrophilic group is at least partially crosslinked with at least one crosslinking agent selected from a silicate, a pyrophosphate, a sugar alcohol, a polycarboxylic acid and an aldehyde.

21. The anode of claim 20, wherein a weight ratio of the at least one polymer with a hydrophilic group and the crosslinking agent is from about 2:1 to about 1:2.

22. The anode claim 20, wherein the crosslinking agent comprises sulfosuccinic acid.

23. The anode of claim 1, wherein the side of the anode that is covered with the polymeric material has been subjected to a surface treatment prior to covering the side with the polymeric material.

24. The anode of claim 23, wherein the surface treatment comprises a hydrophilization treatment.

25. The anode of claim 24, wherein the hydrophilization treatment comprises a treatment with a hydrophilizing agent.

26. The anode of claim 25, wherein the hydrophilizing agent comprises at least one substance selected from anionic surfactants, cationic surfactants, non-ionic surfactants, polycarboxylic acids and salts thereof, oxy-acids and salts thereof, sugars, sugar alcohols, sugar derivatives and cellulose derivatives.

27. An anode for a direct liquid fuel cell in which hydrogen gas is generated as a result of a fuel oxidation or decomposition reaction, wherein a surface of the anode which is intended to face an electrolyte of the fuel cell is substantially completely coated with one or more layers of a polymeric material which comprises at least one of an at least partially crosslinked homopolymer and an at least partially crosslinked copolymer of vinyl alcohol, the anode with the one or more layers thereon having a resistivity of not higher than about 0.9 Ohm·cm² and preventing at least about 90% of the generated hydrogen gas from penetrating the anode into the electrolyte.

28. The anode of claim 27, wherein the polymeric material is at least partially crosslinked with a crosslinking agent selected from one or more of polyethylene glycol, polyethylene oxide and a homo- or copolymer of acrylic acid.

29. The anode of claim 27, wherein the polymeric material is at least partially crosslinked with a crosslinking agent selected from sodium silicate, sodium pyrophosphate, sorbitol, xylitol, formaldehyde, sulfosuccinic acid and combinations of two or more thereof.

30. A liquid fuel cell comprising the anode of claim 1.

31. The fuel cell of claim 30, wherein the fuel cell comprises at least one of a metal hydride and a metal borohydride compound in a fuel chamber thereof.

32. The fuel cell of claim 31, wherein an electrolyte chamber thereof comprises aqueous alkali metal hydroxide.

33. A liquid fuel cell for use with a liquid fuel that is prone to undergo decomposition with generation of hydrogen gas, the fuel cell comprising:
a cathode;
an anode;
an electrolyte chamber arranged between the cathode and the anode;
a fuel chamber arranged on a side of the anode which is opposite to a side which faces the electrolyte chamber; and
one or more layers of polymeric material arranged on a surface of the anode which faces the fuel chamber,
wherein the one or more layers of polymeric material prevent an at least substantial portion of the hydrogen gas that is present in the fuel chamber when liquid fuel is present in the fuel chamber from passing through the anode into the electrolyte chamber.

34. The fuel cell of claim 33, wherein the polymeric material comprises at least one polymer with a hydrophilic group selected from one or more of OH, COOH and SO₃H groups.

35. The fuel cell of claim 34, wherein the at least one polymer with a hydrophilic group comprises a polymer having OH groups which is at least partially crosslinked with at least one crosslinking agent selected from polyethylene glycol, polyethylene oxide, a homo- or copolymer of acrylic acid and combinations thereof.

36. The fuel cell of claim 35, wherein the at least one crosslinking agent comprises at least one of an acrylic acid homopolymer and a copolymer of acrylic acid and maleic acid.

37. The fuel cell of claim 34, wherein the at least one polymer with a hydrophilic group is at least partially crosslinked with at least one crosslinking agent selected from an alkali metal silicate, an alkali metal pyrophosphate, a sugar alcohol, a polycarboxylic acid and an aldehyde.

38. The fuel cell of claim 37, wherein the at least one crosslinking agent comprises sulfosuccinic acid.
